(19) United States
(12) Patent Application Publication
(10) Pub. No.: US 2014/0237327 A1
(43) Pub. Date: Aug. 21, 2014

(54) METHOD, APPARATUS AND SYSTEM FOR TESTING NETWORK UNDER IPSEC MECHANISM

(71) Applicant: Huawei Technologies Co., Ltd., Shenzhen (CN)

(72) Inventors: Xiaoyu BI, Shenzhen (CN); Lei XIE, Beijing (CN)

(73) Assignee: Huawei Technologies Co., Ltd., Shenzhen (CN)

(21) Appl. No.: 14/259,973

(22) Filed: Apr. 23, 2014

Related U.S. Application Data
(63) Continuation of application No. PCT/CN2012/083652, filed on Oct. 29, 2012.

(30) Foreign Application Priority Data
Oct. 28, 2011 (CN) 201110334722.7

(51) Int. Cl. H04L 12/26

(52) U.S. Cl. CPC H04L 43/0847
USPC 714/799

(57) ABSTRACT

Embodiments of the present invention provide a method for testing a network under an IPsec mechanism, and relate to the field of wireless communications, so as to correct an error generated by a disorder of service data packet receiving during network testing under the IPsec mechanism. The method for testing a network under the IPsec mechanism includes: receiving a session request message, where the session request message contains information about a quantity of IPsec data packets and a sending time interval of the IPsec data packets; after a session is established with a sending end, receiving an IPsec data packet that carries testing information; and performing error detection for the received IPsec data packet according to the received testing information as well as the information about the quantity of IPsec data packets and the sending time interval of the IPsec data packets in the session request message.

### CROSS-REFERENCE TO RELATED APPLICATIONS

This application is a continuation of International Patent Application No. PCT/CN2012/083652, filed on Oct. 29, 2012, which claims priority to Chinese Patent Application No. 201110334722.7, filed on Oct. 28, 2011, both of which are hereby incorporated by reference in their entireties.

### TECHNICAL FIELD

The present invention relates to the field of wireless communications, and in particular, to a method, an apparatus, and a system for testing a network under an IPSec mechanism.

### BACKGROUND

After completing planning and deployment of a network, a telecom operator usually pays attention to methods for subsequent network maintenance and fault location, which are specifically, for example, link fault location, a packet loss rate, delay, an error, and other parameter indicators. For a testing method used at an IP layer, the Internet Engineering Task Force (IETF) standard specially defines an IP Performance Metrics (IPPM) workgroup. IPPM is a set of protocol specifications defined by IETF. On one hand, IPPM defines specific items of performance indicators, and on the other hand defines methods for measuring these indicators.

According to the The 3rd Generation Partnership Project (3GPP) standard, an IP security (IPsec) security tunnel is defined for use on a link between an Mobility Management Entity (MME) and an enhanced NodeB (eNB) on an Long Term Evolution (LTE) network to protect security of a transmitted data flow. It provides security protection, such as data integrity, confidentiality, and replay. On a network, a security gateway is generally deployed at an ingress of a core network, so as to ensure security of the telecom operator's core network. Therefore, the security tunnel IPsec between the eNB and the MME may also terminate on the security gateway. For this reason, if a security detection method is considered at the IP layer, maintenance testing after security encryption needs to be processed, because after IPsec protection is used, all data flows exchanged between a base station and the security gateway need to be transmitted in a form of an encrypted packet, making it rather difficult to measure a data flow of a specific service.

A method of maintenance testing for the use of the IPsec security tunnel to protect a transmitted data flow is a method of detection by using some Operation, Administration and Maintenance (OAM) packets. Because such an OAM data packet contains only information such as a quantity and a size of a service data flow, whether the OAM data packet is disordered cannot be determined, and therefore a measurement error may occur because an IPsec receiving end receives a disordered OAM data packet.

### SUMMARY

Embodiments of the present invention provide a method, an apparatus, and a system for testing a network under an IPsec mechanism, so as to correct an error generated by a disorder of service data packet receiving during network testing under an IPsec mechanism in the prior art.

To attain the foregoing objective, the embodiments of the present invention use the following technical solutions:

In one aspect, an embodiment of the present invention provides a method for testing a network under an IPsec mechanism, including:

receiving a session request message, where the session request message contains information about a quantity of IPsec data packets and a sending time interval of the IPsec data packets;

after a session is established with a sending end, receiving an IPsec data packet that carries testing information; and

performing error detection for the received IPsec data packet according to the received testing information as well as the information about the quantity of IPsec data packets and the sending time interval of the IPsec data packets in the session request message.

In one aspect, an embodiment of the present provides another method for testing a network under an IPsec mechanism, including:

sending a session request message, where the session request message contains information about a quantity of data packets and a sending time interval of the data packets; and

after a session is established with a receiving end, sending an IPsec data packet that carries testing information, so that the receiving end performs error detection for the received IPsec data packet according to the testing information in the received IPsec data packet that carries the testing information as well as the information about the quantity of IPsec data packets and the sending time interval of the IPsec data packets in the session request message.

In one aspect, an embodiment of the present invention provides a receiving terminal, including:

a first receiving unit, configured to receive a session request message, where the session request message contains information about a quantity of IPsec data packets and a sending time interval of the IPsec data packets;

a second receiving unit, configured to receive an IPsec data packet that carries testing information; and

a detecting unit, connected to the first receiving unit and the second receiving unit, and configured to perform error detection for the received IPsec data packet according to the testing information received by the second receiving unit as well as the information about the quantity of IPsec data packets and the sending time interval of the IPsec data packets in the session request message that is received by the first receiving unit.

In another aspect, an embodiment of the present invention further provides a sending terminal, including:

a first sending unit, configured to send a session request message; and

a second sending unit, configured to send an IPsec data packet that carries testing information.

In still another aspect, an embodiment of the present invention provides a system for testing a network under an IPsec mechanism, including:

a sending terminal, configured to send a session request message and send an IPsec data packet that carries testing information; and

a receiving terminal, configured to receive the session request message and receive the IPsec data packet that carries the testing information; where

the receiving terminal is further configured to perform error detection for the received IPsec data packet according to the received testing information as well as information about a quantity of IPsec data packets and a sending time interval of the IPsec data packets in the session request message.

In the method, apparatus, and system for testing a network under an IPsec mechanism according to the embodiments of the present invention, first a session request message is sent for an IPsec data packet to be tested, so as to determine information such as a quantity of IPsec data packets to be sent and a sending time interval of the IPsec data packets; and then information, such as a sequence number, a timestamp, and error estimation, is added to the IPsec data packet to be sent, and the IPsec data packet is detected, thereby resolving the following problem: When an OAM data packet that carries only information about a data packet size and a quantity of data packets is received under the IPsec mechanism, a measurement error occurs because a data packet disorder cannot be determined.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a flowchart of a method according to an embodiment of the present invention;

FIG. 2 is a flowchart of another method according to an embodiment of the present invention;

FIG. 3 is a flowchart of another method according to an embodiment of the present invention;

FIG. 4 is a diagram of a format of a session request message according to an embodiment of the present invention;

FIG. 5 is a diagram of another format of a session request message according to an embodiment of the present invention;

FIG. 6 is a diagram of a format of a data packet header according to an embodiment of the present invention;

FIG. 7 is a diagram of another format of a data packet header according to an embodiment of the present invention;

FIG. 8 is a schematic structural diagram of a receiving terminal according to an embodiment of the present invention;

FIG. 9 is a schematic structural diagram of a sending terminal according to an embodiment of the present invention; and

FIG. 10 is a schematic structural diagram of a system for detecting a network according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

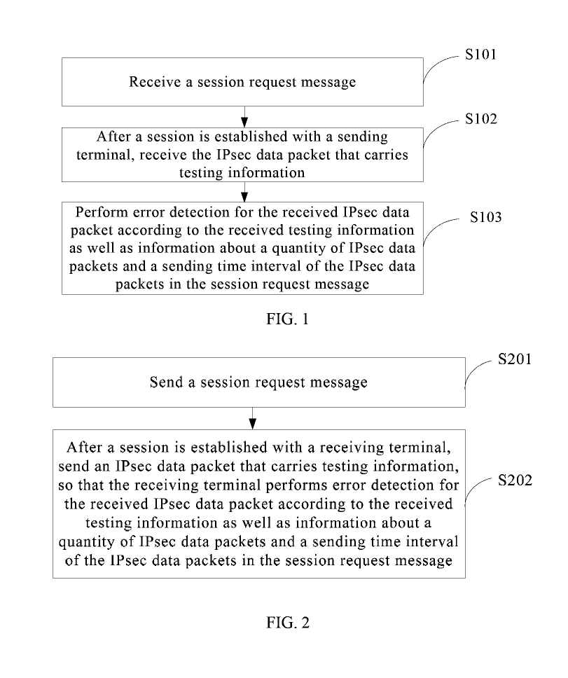

A method for testing a network under an IPsecmechanism provided by an embodiment of the present invention relates to a side of a receiving terminal. As shown in FIG. 1, the method includes the following steps:

S101. Receive a session request message.

In this embodiment of the present invention, the session request message contains information about a quantity of IPsec data packets and a sending time interval of the IPsec data packets.

S102. After a session is established with a sending terminal, receive an IPsec data packet that carries testing information.

Specifically, after a session is established with the sending terminal, the sending terminal starts preparing to send a data packet, where the data packet carries testing information. The receiving terminal acquires the testing information from the data packet, and performs error detection for the received data packet.

S103. Perform the error detection for the received IPsec data packet according to the received testing information as well as the information about the quantity of IPsec data packets and the sending time interval of the IPsec data packets in the session request message.

Specifically, in this embodiment of the present invention, the IPsec data packet carries the testing information, where the testing information includes a sequence number, a timestamp, and error estimation of the data packet. After acquiring the testing information from the IPsec data packet, a receiving end sorts, according to the sequence number of the data packet and sending time indicated by the timestamp in the testing information, received IPsec data packets; and then tests, through the quantity of sent IPsec data packets in the previous session request message, whether the sent IPsec data packet is disordered. In addition, the IPsec receiving terminal may further perform delay detection according to the sending time indicated by the timestamp of the data packet in the testing information, and the negotiated sending time interval and first sending time of the IPsec data packets in the session request message; and perform, according to the quantity of received IPsec data packets and the negotiated quantity of IPsec data packets to be sent in the session request message, detection on a packet loss rate.

In the method for testing a network under an IPsec mechanism according to this embodiment of the present invention, a receiving terminal receives a session request message from a sending terminal, so that information, such as a quantity of IPsec data packets to be sent and a sending time interval of the IPsec data packets, is first determined; and a received IPsec data packet is then detected by acquiring information carried in a sent IPsec data packet, such as a sequence number, a timestamp, and error estimation, thereby resolving the following problem: In the case that no session request message is sent for exchanging information about the data packets to be sent, when an OAM data packet that carries only information about a data packet size and a quantity of data packets is directly sent, a measurement error occurs because a data packet disorder cannot be determined.

An embodiment of the present further provides a method for testing a network under an IPsec mechanism, and relates to a side of a sending terminal. The method includes the following steps:

S201. Send a session request message.

The session request message contains information about a quantity of IPsec data packets and a sending time interval of the IPsec data packets.

S202. After a session is established with a receiving terminal, send an IPsec data packet that carries testing information, so that the receiving terminal performs error detection for the received IPsec data packet according to the received testing information as well as the information about the quantity of IPsec data packets and the sending time interval of the IPsec data packets in the session request message.

Specifically, after a session is established with the receiving terminal, the sending terminal sends an IPsec data packet and adds testing information to the data packet, where the testing information includes information, such as a sequence number, a timestamp, and error estimation of the sent IPsec data packet, so that the receiving terminal performs error detection for the received IPsec data packet according to the received testing information as well as the information about the quantity of data packets and the sending time interval of the data packets in the session request message.

In the method for testing a network under an IPsec mechanism according to this embodiment of the present invention, a sending terminal of IPsec data packets sends a session request message to a receiving terminal, so that information, such as a quantity of IPsec data packets to be sent and a sending time interval of the IPsec data packets, is first determined; and an IPsec data packet that carries information such as a sequence number, a timestamp, and error estimation is then sent, so that the receiving terminal performs detection on the IPsec data packet, thereby resolving the following problem: In the case that no session request message is sent for exchanging information about the data packets to be sent, when an OAM data packet that carries only information about a data packet size and a quantity of data packets is directly sent, a measurement error occurs because a data packet disorder cannot be determined.

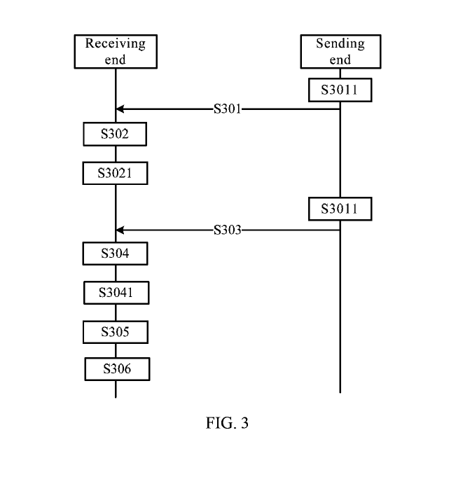

A method for testing a network under an IPsec mechanism provided by another embodiment of the present invention, as shown in FIG. 3, includes the following steps:

S301. A sending terminal sends a session request message.

In this embodiment of the present invention, the session request message contains information about a quantity of IPsec data packets and a sending time interval of the IPsec data packets. Preferentially, the session request message may further include information, such as User Datagram Protocol UDP (UDPU) ports for sending and receiving the data packets and sending start time of the IPsec data packets, may be further included.

Preferentially, in this embodiment of the present invention, the sending a session request message further includes:

S3011. Add information about a service flow to be tested to the session request message. Specifically, there are two schemes:

Scheme 1: Directly add the information about the service flow to be tested, where the information about the service flow to be tested may be a source address, a destination address, a source port number, a destination port number, and a DSCP value of an IPsec data packet of the service flow to be tested; or may also be one or a plurality of other identification groups that can identify the service flow information.

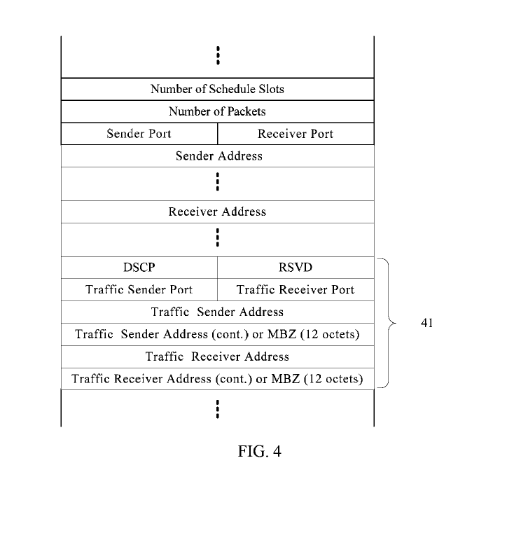

Specifically, FIG. 4 shows a format of the sent session request message by using an example in which the source address, the destination address, the source port number, the destination port number, and the DSCP value of an IPsec data packet of the service flow to be tested are added, where 41 is a content portion of the added service flow. The content portion of the added service flow mainly includes: Traffic Sender Port/Traffic Receiver Port, indicating a specific source/destination port number of the data packet of the service flow to be tested; and Traffic Sender Address/Traffic Receiver Address, indicating a specific sending/receiving end address of the data packet of the service flow to be tested.

It should be noted that because a dedicated 861 port is used during a test, generally in an end-to-end scenario, Addresses of a sending end and a receiving terminal of a test packet are usually the same as a sending end address and a receiving end address of a service data packet to be measured. Therefore, the address information can be omitted. The Differentiated Services Code Point (DSCP) value may be defined by using one or two bytes. In addition, a position where the added content resides may be but not limited to that shown in FIG. 4, or may also be behind a sending port (Sender Port/Receiver Port), which is a UDP port for sending/receiving the test data packet.

Scheme 2: Add an identification bit and information about an IPsec data packet to be tested, such as a source port number and a destination port number, to the session request message; or add an identification bit and one or a plurality of identification groups that can identify an IPsec data packet service to the session request message, so that the receiving end performs error detection for a received IPsec data packet according to the source port number and the destination port number in the session request message.

Specifically, FIG. 5 shows a format of the sent session request message by using an example in which the identification bit and the information such as the source port number and the destination port number of an IPsec data packet to be tested are added to the session request message, where 51 is a content portion of the added service flow . The content portion of the added service flow mainly includes: Enable, indicating the identification bit, which is an identification bit used to indicate that content of the session request is negotiated detection of performance of the service flow to be tested; Traffic Sender Port/Traffic Receiver Port, indicating a specific source/destination port number of the data packet of the service flow to be tested; and Traffic Sender Address/Traffic Receiver Address, indicating a sending/receiving end address of the data packet of the service flow to be tested.

S302. The receiving terminal receives the session request message.

Specifically, the receiving terminal acquires the information about the quantity of IPsec data packets and the sending time interval of the IPsec data packets, and the like from the received session request message.

Preferentially, after the receiving the session request message, the following step is further included:

S3021. Detect whether the identification bit exists in the session request message. When the identification bit exists, the receiving terminal performs the error detection according to the source port number and the destination port number of the IPsec data packet service in the session request message, or according to one or a plurality of identifiers that can identify the IPsec data packet service.

S303. After a session is established with the receiving terminal, send an IPsec data packet that carries testing information, so that the receiving terminal performs the error detection for the received IPsec data packet according to the received testing information as well as the information about the number of IPsec data packets and the sending time interval of the IPsec data packets in the session request message.

Specifically, there may be two cases of sending an IPsec data packet that carries testing information:

In a first case, the sending terminal sends an IPsec data packet in which testing information of the IPsec data packet and a length of the testing information are placed in a packet header of the IPsec data packet, where the testing information includes at least a sequence number, a timestamp, and error estimation information of the IPsec data packet.

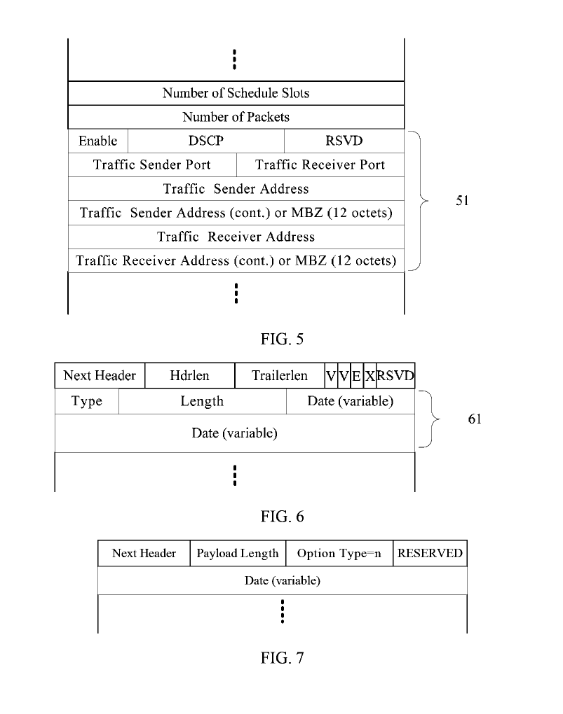

Optionally, the packet header may be an extended header of the Wrapped Encapsulating Security Payload (WESP) protocol, and FIG. 6 shows a specific format, where 61 is a content portion of the added packet header. The content portion of the added packet header mainly includes: Type, indicating whether the testing information is in an encrypted mode; Length, indicating the length of the testing information; and Date, indicating specific content of the testing information.

Optionally, the packet header may also be a newly-defined IP4 or IP6 extended header, and FIG. 7 shows a specific format. A value of n is set in Option Type=n, indicating whether the testing information is in an encrypted mode; Payload length indicates the length of the testing information; and Date indicates the specific content of the testing information, and the Date portion is left blank when the testing information is in an encrypted authentication mode.

In a second case, the sending end sends an IPsec data packet in which testing information of the IPsec data packet is placed in a payload of the IPsec data packet and a length of the testing information is placed in a packet header of the IPsec data packet, where the testing information includes a sequence number, a timestamp, and error estimation information of the IPsec data packet.

Specifically, the sending terminal may selectively place the testing information in first several bits or last several bits of the payload, with the packet header describing the specific length of the testing information in the IPsec data packet or a specific length of the data packet, so as to obtain the IPsec data packet and the testing information thereof after the IPsec data packet is decrypted.

Optionally, the packet header may be an extended header of the WESP protocol, or a newly-defined IP4 or IP6 extended header.

A specific format of the extended header is the same as the one used in an unencrypted authentication mode, except that the Date portion is left blank when the testing information is in an encrypted authentication mode, and no description is further made herein with reference to an accompanying drawing.

Preferentially, in this embodiment of the present invention, before the sending an IPsec data packet that carries testing information, the following step is further included:

S3031. Set a testing start bit. One bit of RSVD may be selected as the testing start bit. In addition, if an X bit is 1, DATA contains standard measurement information, and a calculated value of integrity protection needs to be added behind the DATA. In addition, an idle bit in an IP header, such as an idle bit of TOS/DSCP, may be used as the testing start bit.

S304. The receiving terminal receives the IPsec data packet that carries the testing information.

Preferentially, after the receiving the IPsec data packet that carries the testing information, the following step is further included:

S3041: Detect the testing start bit in the data packet header, so as to determine whether error detection is started. If the testing start bit indicates that the error detection is not started, no error detection is performed for the IPsec data packet; or if the testing start bit indicates that the error detection is started, the testing information continues to be acquired and the error detection is performed according to the testing information and the information in the session request message.

S305. Decrypt the received IPsec data packet, so as to acquire the testing information carried in the IPsec data packet, where the IPsec data packet carries the testing information.

After receiving the IPsec data packet, the receiving terminal decrypts the IPsec data packet, and then acquires the testing information from the data packet and performs the error detection for the received data packet. There may be two cases of acquiring the testing information:

In a first case, the testing information is directly located in the packet header of the data packet, where the packet header may be an extended header of the WESP protocol, or may be a newly-defined IP4 or IP6 extended header. After decrypting the received IPsec data packet, the receiving end may directly acquire the testing information from the data packet header. The testing information includes at least the sequence number, the timestamp, and the error estimation information of the IPsec data packet.

In a second case, the testing information is placed in the payload of the IPsec data packet, and the length of the testing information is placed in the packet header of the IPsec data packet, where the packet header may be an extended header of the WESP protocol, or may be a newly-defined IP4 or IP6 extended header. After decrypting the received IPsec data packet, the receiving end acquires, according to the specific length of the testing information or the specific length of the data packet, the testing information in the first several bits or the last several bits of the payload of the IPsec data packet.

S306. Perform the error detection for the received IPsec data packet according to the received testing information as well as the information about the quantity of IPsec data packets and the sending time interval of the IPsec data packets in the session request message.

Specifically, after acquiring the testing information of the IPsec data packet, the receiving end performs disorder detection for the data packet according to the sequence number and the timestamp of the data packet in the testing information. In addition, the receiving terminal may further perform delay detection according to the timestamp of the data packet in the testing information and the negotiated sending time interval of the IPsec data packets in the session request message; and perform, according to the quantity of received IPsec data packets and the negotiated quantity of IPsec data packets to be sent in the session request message, detection on a packet loss rate.

It should be noted that in this embodiment of the present invention, the format of the session request message may be consistent with a format of a session request message specified in the IPPM protocol. The unencrypted authentication mode and the encrypted authentication mode of the testing information of the data packet may also be consistent with a testing information format specified in the IPPM protocol.

In another method for testing a network under an IPsec mechanism according to this embodiment of the present invention, first a session request message is sent for an IPsec data packet to be tested, so as to determine information such as a quantity of IPsec data packets to be sent and a sending time interval of the IPsec data packets; and then information, such as a sequence number, a timestamp, and error estimation, is added to the IPsec data packet to be sent, and the IPsec data packet is detected, thereby resolving the following problem: When an OAM data packet that information about carries only a data packet size and a quantity of data packets is received under the IPsec mechanism, a measurement error occurs because a data packet disorder cannot be determined. A send parameter is negotiated in a session request for the data packet to be detected, and the information, such as the sequence number, the timestamp, and the error estimation, is added to the data packet, thereby resolving the measurement error problem caused by receiving of a disordered data packet under IPsec. Further, in this embodiment, information about a specific data service to be detected is added to the session request message, thereby further implementing detection for data flows of different granularities.

An embodiment of the present invention further provides an apparatus for testing a network under an IPsec mechanism. The following describes the apparatus by using an example.

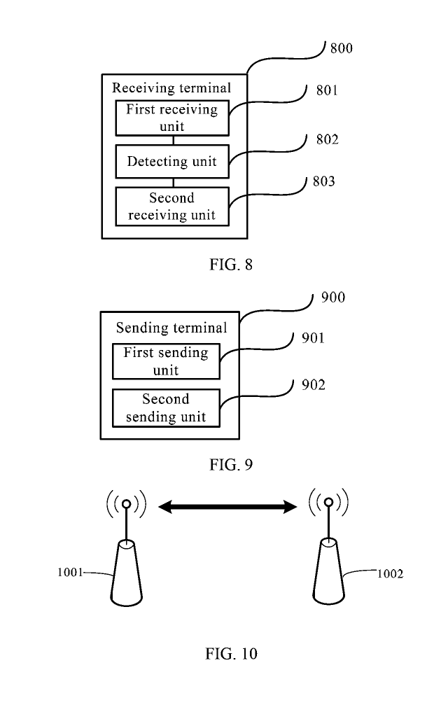

As shown in FIG. 8, an embodiment of the present invention provides a receiving terminal 800, which includes:

a first receiving unit 801, a second receiving unit 802, and a detecting unit 803, where the first receiving unit 801 is configured to receive a session request message; the second receiving unit 802 is configured to receive an IPsec data packet that carries testing information; and the detecting unit 803 is configured to perform error detection for the received IPsec data packet according to the testing information received by the second receiving unit as well as information about a quantity of data packets and a sending time interval of the data packets in the session request message that is received by the first receiving first unit.

Optionally, the second receiving unit 802 is further configured to decrypt the IPsec data packet, so as to acquire the testing information carried in the IPsec data packet, where the IPsec data packet carries the testing information, and the testing information includes a sequence number, a timestamp, and error estimation information of the IPsec data packet.

Optionally, the detecting unit 803 is further configured to perform disorder detection for the IPsec data packet according to a sequence number and a timestamp of the data packet in the received testing information as well as the quantity of IPsec data packets in the session request message; and/or

perform delay detection according to a timestamp of the IPsec data packet in the testing information and the sending time interval of the IPsec data packets in the session request message, and perform, according to the quantity of received IPsec data packets and the quantity of IPsec data packets in the session request message, detection on a packet loss rate.

As shown in FIG. 9, an embodiment of the present invention provides a sending terminal 900, including:

a first sending unit 901 and a second sending unit 902, where the first sending unit 901 is configured to send a session request message; and the second sending unit 902 is configured to send an IPsec data packet that carries testing information.

Optionally, the first sending unit 901 may be further configured to send the session request message that carries an identification bit, a source port number, and a destination port number of the IPsec data packet.

Optionally, the first sending unit 901 may also add an identification bit and one or a plurality of identification groups that can identify an IPsec data packet service, so that a receiving terminal performs error detection for the received IPsec data packet according to the source port number and the destination port number in the session request message.

Optionally, the second sending unit 902 may be further configured to send the IPsec data packet that carries the testing information, where the testing information and a length value of the testing information are placed in a packet header of the IPsec data packet, and the testing information includes a sequence number, a timestamp, and error estimation information of the IPsec data packet.

In addition, the second sending unit 902 is further configured to send the IPsec data packet that carries the testing information, where the testing information is placed in a payload of the IPsec data packet, a length value of the testing information is placed in a packet header of the IPsec data packet, and the testing information includes a sequence number, a timestamp, and error estimation information of the IPsec data packet.

Preferentially, the first sending unit 901 of the sending terminal 900 may be further configured to send the session request message, where the session request message carries a source port number, a destination port number, and/or an identification bit of the IPsec data packet, and one or a plurality of identification groups that can identify the IPsec data packet service, so that a receiving end performs the error detection for the received IPsec data packet according to the source port number and the destination port number of the IPsec data packet in the session request message.

In this embodiment of the present invention, the sending terminal and the receiving terminal may be a router or a base station.

According to the apparatus for testing a network under an IPsec mechanism provided in this embodiment of the present invention, first a session request message is sent for an IPsec data packet to be tested, so as to determine information such as a quantity of IPsec data packets to be sent and a sending time interval of the IPsec data packets; and then information, such as a sequence number, a timestamp, and error estimation, is added to the IPsec data packet to be sent, and the IPsec data packet is detected, thereby resolving the following problem: When an OAM data packet that information about carries only a data packet size and a quantity of data packets is received under the IPsec mechanism, a measurement error occurs because a data packet disorder cannot be determined. Further, in this embodiment, in the session request message, information about a specific data service to be detected is added, thereby further implementing detection for data flows of different granularities.

According to the apparatus for testing a network under an IPsec mechanism provided in this embodiment of the present invention, first a send parameter is negotiated in a session request for a data packet to be detected, and information, such as a sequence number, a timestamp, and error estimation, is added to the data packet, thereby resolving a measurement error problem caused by receiving of a disordered data packet under IPsec. Further, in this embodiment, information about a specific data service to be detected is added to the session request message sent by a sending terminal, thereby further implementing detection for data flows of different granularities.

An embodiment of the present invention further provides a system for testing a network under an IPsec mechanism. As shown in FIG. 10, the system includes: a sending terminal 1001 and a receiving terminal 1002. The sending terminal 1001 is configured to send a session request message and send an IPsec data packet that carries testing information. The receiving terminal 1002 is configured to receive the session request message and receive the IPsec data packet that carries the testing information. The receiving terminal 1002 is further configured to perform error detection for the received IPsec data packet according to the received testing information as well as information about a quantity of data packets and a sending time interval of the data packets in the session request message.

Under the IPsec mechanism, after the receiving terminal receives the session request message sent by the sending terminal, the receiving terminal establishes a session with the sending terminal, where the session request message contains specific content of session negotiation. After the session is established, the receiving terminal receives the IPsec data packet, where the IPsec data packet is sent by the sending terminal according to negotiated time and a path in the session request. After receiving the IPsec data packet that carries the testing information, the receiving terminal processes the IPsec data packet, acquires the testing information, and performs the error detection for the received IPsec data packet according to the received testing information and the information about the quantity of data packets and the sending time interval of the data packets in the session request message.

In the system for testing a network under an IPsec mechanism according to this embodiment of the present invention, first a session request message is sent for an IPsec data packet to be tested, so as to determine information such as a quantity of IPsec data packets to be sent and a sending time interval of the IPsec data packets; and then information, such as a sequence number, a timestamp, and error estimation, is added to the IPsec data packet to be sent, and the IPsec data packet is detected, thereby resolving the following problem: When an OAM data packet that information about carries only a data packet size and a quantity of data packets is received under the IPsec mechanism, a measurement error occurs because a data packet disorder cannot be determined.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for testing a network under an IPsec mechanism, comprising:
receiving a session request message, wherein the session request message comprises information about a quantity of IPsec data packets and a sending time interval of the IPsec data packets;
after a session is established with a sending end, receiving an IPsec data packet that carries testing information; and
performing error detection for the received IPsec data packet according to the received testing information as well as the information about the quantity of IPsec data packets and the sending time interval of the IPsec data packets in the session request message.

2. The method according to claim 1, after the receiving the IPsec data packet that carries the testing information, further comprising:
decrypting the IPsec data packet, so as to acquire the testing information carried in the IPsec data packet, wherein the testing information comprises a sequence number, a timestamp, and error estimation information of the IPsec data packet.

3. The method according to claim 1, wherein the performing the error detection for the received IPsec data packet according to the received testing information as well as the information about the quantity of IPsec data packets and the sending time interval of the IPsec data packets in the session request message comprises:
performing disorder detection for the IPsec data packet according to the sequence number and the timestamp of the data packet in the received testing information as well as the quantity of IPsec data packets in the session request message; and/or
performing delay detection according to the timestamp of the IPsec data packet in the testing information and the sending time interval of the IPsec data packets in the session request message, and performing, according to the quantity of received IPsec data packets and the quantity of IPsec data packets in the session request message, detection on a packet loss rate.

4. A method for testing a network under an IPsec mechanism, comprising:
sending a session request message, wherein the session request message contains information about a quantity of IPsec data packets and a sending time interval of the IPsec data packets; and
after a session is established with a receiving end, sending an IPsec data packet that carries testing information, so that the receiving end performs error detection for the received IPsec data packet according to the testing information in the received IPsec data packet that carries the testing information as well as the information about the quantity of IPsec data packets and the sending time interval of the IPsec data packets in the session request message.

5. The method according to claim 4, wherein the session request message further carries an identification bit, a source port number, and a destination port number of the IPsec data packet.

6. The method according to claim 4, wherein the sending the IPsec data packet that carries the testing information comprises:
sending the IPsec data packet that carries the testing information, wherein the testing information and a length value of the testing information are placed in a packet header of the IPsec data packet, and the testing information comprises a sequence number, a timestamp, and error estimation information of the IPsec data packet.

7. The method according to claim 4, wherein the sending the IPsec data packet that carries the testing information comprises:
sending the IPsec data packet that carries the testing information, wherein the testing information is placed in a payload of the IPsec data packet, a length value of the testing information is placed in a packet header of the IPsec data packet, and the testing information comprises a sequence number, a timestamp, and error estimation information of the IPsec data packet.

8. The method according to claim 5, wherein the session request message further carries the source port number, the destination port number, and/or the identification bit of the IPsec data packet, and one or a plurality of identification groups that can identify the IPsec data packet service, so that the receiving end performs the error detection for the received IPsec data packet according to the source port number and the destination port number of the IPsec data packet in the session request message.

9. A receiving terminal, comprising:
a receiver, configured to receive a session request message, wherein the session request message contains information about a quantity of IPsec data packets and a sending time interval of the IPsec data packets;
the receiver, configured to receive an IPsec data packet that carries testing information; and
a processor, connected to the receiver, and configured to perform error detection for the received IPsec data packet according to the testing information received by receiver as well as the information about the quantity of IPsec data packets and the sending time interval of the IPsec data packets in the session request message that is received by the first receiver.

10. The receiving terminal according to claim 9, wherein the receiver is further configured to decrypt the IPsec data packet, so as to acquire the testing information carried in the IPsec data packet, wherein the IPsec data packet carries the testing information, and the testing information comprises a sequence number, a timestamp, and error estimation information of the IPsec data packet.

11. The receiving terminal according to claim 9, wherein the processor is specifically configured to perform disorder detection for the IPsec data packet according to a sequence number and a timestamp of the data packet in the received testing information as well as the quantity of IPsec data packets in the session request message; and/or
perform delay detection according to a timestamp of the IPsec data packet in the testing information and the sending time interval of the IPsec data packets in the session request message, and perform, according to the quantity of received IPsec data packets and the quantity of IPsec data packets in the session request message, detection on a packet loss rate.

12. A sending terminal, comprising:
a transmitter, configured to send a session request message, wherein the session request message contains information about a quantity of IPsec data packets and a sending time interval of the IPsec data packets; and
the transmitter, configured to, after a session is established with a receiving end, send an IPsec data packet that carries testing information, so that the receiving end performs error detection for the received IPsec data packet according to the testing information in the received IPsec data packet that carries the testing information as well as the information about the quantity of IPsec data packets and the sending time interval of the IPsec data packets in the session request message.

13. The sending terminal according to claim 11, wherein the transmitter is further configured to send the session request message that carries an identification bit, a source port number, and a destination port number of the IPsec data packet.

14. The sending terminal according to claim 11, wherein the transmitter is specifically configured to send the IPsec data packet that carries the testing information, wherein the testing information and a length value of the testing information are placed in a packet header of the IPsec data packet, and the testing information comprises a sequence number, a timestamp, and error estimation information of the IPsec data packet.

15. The sending terminal according to claim 11, wherein the transmitter is specifically configured to send the IPsec data packet that carries the testing information, wherein the testing information is placed in a payload of the IPsec data packet, a length value of the testing information is placed in a packet header of the IPsec data packet, and the testing information comprises a sequence number, a timestamp, and error estimation information of the IPsec data packet.

16. The sending terminal according to claim 11, wherein the transmitter is further configured to send the session request message, wherein the session request message carries a source port number, a destination port number, and/or an identification bit of the IPsec data packet, and one or a plurality of identification groups that can identify the IPsec data packet service, so that a receiving end performs the error detection for the received IPsec data packet according to a source port number and a destination port number of the IPsec data packet in the session request message.

17. A system for testing a network under an IPsec mechanism, comprising:
a sending terminal, configured to send a session request message and send an IPsec data packet that carries testing information; and
a receiving terminal, configured to receive the session request message and receive the IPsec data packet that carries the testing information; wherein
the receiving terminal is further configured to perform error detection for the received IPsec data packet according to the received testing information as well as information about a quantity of data packets and a sending time interval of the data packets in the session request message.
